(19) United States
(12) Patent Application Publication
(10) Pub. No.: US 2025/0377059 A1
(43) Pub. Date: Dec. 11, 2025

(54) Jacketed Pipe Pump

(71) Applicant: WEIR MINERALS U.S. INC., WEST VALLEY CITY, UT (US)

(72) Inventors: Jay Edward Scherbik, Millstadt, IL (US); Tracy Bridgeman, Cuba, MO (US); Biji Ponraj, Bengaluru (IN)

(21) Appl. No.: 18/876,118

(22) PCT Filed: Jun. 30, 2023
(86) PCT No.: PCT/IB2023/056855

§ 371 Date: Dec. 17, 2024

Related U.S. Application Data
(60) Provisional application No. 63/389,397, filed on Jul. 15, 2022.

(30) Foreign Application Priority Data
Jul. 29, 2022 (GB) 2211133.0

(51) Int. Cl. F16L 39/00; F04D 29/42; F04D 29/62; F16L 53/30; F16L 53/70

(52) U.S. Cl. CPC F16L 39/005; F04D 29/42; F04D 29/62; F16L 53/30; F16L 53/70

(57) ABSTRACT

A jacketed pipe pump includes a manifold system for use in directing mediating fluid between annular spaces formed in adjacently-positioned jacketed pipes, each jacketed pipe comprising an internal pipe and an external pipe having an annular space therebetween for the flow of a mediating fluid therein, the manifold system also being useful for flowing fluid from a jacketed pipe to a pump casing configured with a conduit that is positioned not in fluid communication with the pump chamber of the pump casing, but which is positioned to direct mediating fluid from an attached jacketed pipe through the conduit of the pump casing for movement of the mediating fluid to further communicating pipe systems.

### TECHNICAL FIELD

This disclosure relates in general to a jacketed pipe pump for pumping fluids between including one or more jacketed pipe spools and a pump casing.

### BACKGROUND OF THE DISCLOSURE

Jacketed pipe pumps are commonly used to direct a fluid of some sort in a space provided between an inner pipe and a co-axially arranged outer pipe. Such jacketed pipe systems are often used to transport a mediating fluid to maintain the temperature of a main fluid flowing through the inner pipe, such as flowing a refrigerant between the outer pipe and inner pipe of a jacketed piping system to reduce the temperature of a heated fluid passing through the inner pipe.

Jacketed pipes are frequently used in industries where numerous and lengthy pipe arrangements must be employed to transfer the main fluid in the inner pipe between points that are at great distances apart from each other. Jacketed pipes have certain limitations of length and configuration, so shorter lengths of jacketed pipes, often referred to a jacketed pipe spools, are joined end-to-end over long distances or within complex transporting venues. Consequently, systems for transmitting the mediating fluid that surrounds the inner pipe from pipe spool to pipe spool have been developed.

A well-known apparatus devised to transport the mediating fluid between adjacent pipe spools is disclosed in U.S. Pat. No. 7,226,089 to Wilkinson, et al., which comprises a bell-shaped housing that connects to the end of the outer pipe of the jacketed pipe and which has a flange with openings that provide flow of mediating fluid between adjacently positioned flanges. The arrangement of U.S. Pat. No. 7,226,089 is directed to providing improved sealing between adjacent flanges, as well.

Other devices have been developed for providing encircling flange housings to facilitate the flow of mediating fluid between adjacently-connected jacketed pipe systems, such as those disclosed in U.S. Pat. No. 8,991,871 to Weinhold, U.S. Application No. 2010/0123306 to Jones, and U.S. Pat. No. 1,497,652 to Browne.

Other systems for transmitting a mediating fluid, such as steam, have been employed where external piping is attached to and between the outer pipes of adjacently-positioned jacketed pipe spools to provide a “bridge” of multiple smaller pipes that are connected together in a configuration that transmit the steam or gas from one jacketed pipe system to the next, rather than transmitting the fluid between a flanged system as disclosed in the patents cited previously. The use of such external piping systems presents a problem in additional cost and manpower to fit the multiple pipes together, but also exposes the piping to potential interference, damage and failure.

### SUMMARY

In a first aspect of the present disclosure, an arrangement for directing fluid through a jacketed pipe system is provided which comprises an internal pipe having a wall with an outer surface; an external pipe coaxially arranged around the internal pipe to form an annular space between an inner surface of a wall of the external pipe and the outer surface of the internal pipe; a flange connected to an end of the external pipe, the flange having at least one aperture extending through the thickness of the flange and being radially spaced from the point of connection of the flange to the outer surface of the external pipe; an opening formed through the wall of the external pipe near a point of connection of the flange to the external pipe, the opening being in fluid communication with the annular space between the internal pipe and the external pipe and being located in radial proximity to the at least one aperture formed through the flange; and a manifold device connected to the outer surface of the external pipe and connected to the flange, the manifold device being positioned to enclose the opening formed in the external pipe and to enclose the aperture extending through the flange, the manifold device being formed with a channel providing a fluid pathway between the opening in the external pipe and the aperture in the flange. The arrangement for directing fluid has the advantage of eliminating external piping systems between communicating fluid systems, such as adjacent jacketed pipe spools, and eliminates the complexities of known housing devices used for transmitting a mediating fluid between piping systems.

In certain embodiments, the at least one manifold device or manifold block has a first face that is positioned against a first surface of the flange, the channel being formed in the first face of the at least one manifold block.

In some embodiments, the at least one manifold block has an opposing face that is positioned in opposing orientation to the first face of the at least one manifold block.

In certain embodiments, an access port is formed in an opposing face of the at least one manifold block, the access port being in fluid communication with the channel of the at least one manifold block.

In some embodiments, the access port is oriented at an angle to a longitudinal axis formed along the channel.

In other embodiments, the angle of orientation of the access port is perpendicular to the channel and the opposing face is a second face that is positioned parallel to the first face of the manifold block, the access port being formed through the second face.

In yet other embodiments, the angle of orientation of the access port relative to the longitudinal axis of the channel is an acute angle.

In some embodiments, the access port has an inner wall that is threaded.

In certain embodiments, the at least one manifold block is further provided with a third face that is positioned against the wall of the external pipe and is connected to the wall of the external pipe.

In some embodiments, the at least one manifold block is secured to the external pipe and to the flange by welds.

In yet some other embodiments, the arrangement for directing fluid further comprises a pump casing attached to the flange, the pump casing having a back wall forming, in part, a pump chamber, and having a discharge pipe, the pump casing further comprising a conduit formed along the back wall and along the discharge pipe, the conduit being external to the pump chamber and the discharge pipe, the conduit having a first opening positioned in the back wall of the pump casing and aligned with the aperture formed through the flange connected to the external pipe to receive fluid from the annular space between the inner pipe and the outer pipe, the conduit having a second opening located in proximity to the discharge pipe.

In other certain embodiments, the discharge pipe of the pump casing further comprises a discharge flange located at an end of the discharge pipe, and wherein the conduit extends to and through the discharge flange, the second opening of the conduit being formed through the discharge flange of the discharge pipe.

In yet other embodiments, the arrangement further comprises a connector pipe having a first radial flange for securement to the discharge flange of the discharge pipe, and having a second radial flange located at an opposing end of the connector pipe for securing the connector pipe to other piping elements, the connector pipe having a connector pipe conduit formed along an outer surface of the connector pipe and having a first opening positioned through the first radial flange in alignment with the second opening of the conduit formed in the discharge pipe, and having a second opening formed through the second radial flange.

In a second aspect of the disclosure, there is provided a centrifugal pump casing, comprising a back wall and circumferential wall defining, in combination, a volute; a discharge pipe extending from the volute and having an outlet spaced from the volute; and a conduit providing a fluid pathway from the back wall to the outlet of the discharge pipe, the conduit being positioned to not be in fluid communication with the volute or the discharge pipe. This aspect provides an improved system for transporting a secondary or mediating fluid from a jacketed pipe to a pump casing for release or recirculation of the secondary or mediating fluid at the point of connection of a jacketed pipe to a pump casing.

In some embodiments, the conduit has an entrance opening formed in an outer surface of the back wall and an exit opening formed at the outlet of the discharge pipe.

In certain other embodiments, the discharge pipe further comprises a discharge flange positioned at the outlet, and wherein the exit opening of the conduit is formed through the discharge flange.

In yet other embodiments, the conduit comprises a bore formed through a portion of the back wall, the bore extending along a plane that is parallel to a plane in which the back wall lies.

In still other embodiments, the conduit lies, in part, within a sleeve formed along the outer surface of the discharge pipe.

In some embodiments, the centrifugal pump further comprises a connector pipe having a first radial flange for securement to the discharge flange of the discharge pipe, and having a second radial flange located at an opposing end of the connector pipe for securing the connector pipe to other piping elements, the connector pipe having a connector pipe conduit formed along an outer surface of the connector pipe and having a first opening positioned through the first radial flange in alignment with the exit opening of the conduit formed in the discharge flange of the discharge pipe, and having a second opening formed through the second radial flange.

In a third aspect, a method of directing fluid from a jacketed pipe to a communicating fluid pathway comprises providing a jacketed pipe comprising an inner pipe and an external pipe encircling the inner pipe to provide an annular space between the inner pipe and the external pipe, the external pipe having a flange connected to an end of the external pipe and having an opening formed through the wall of the external pipe near the point of connection of the external pipe to the flange, the flange having an aperture formed through the flange and being spaced at a distance from the wall of the external pipe; providing a manifold device secured to an outer surface of the external pipe and secured to the flange connected to the external pipe, the manifold device having a channel formed therein, the channel being positioned in fluid communication with the opening in the external pipe and in fluid communication with the aperture formed through the flange; and directing fluid from the annular space between the inner pipe and the external pipe through the opening in the external pipe to the aperture in the flange via the channel formed in the manifold device and directing the fluid to a communicating fluid pathway. This aspect provides an improved and simplified process for transmitting a secondary or mediating fluid between jacketed pipe spools or between a jacketed pipe and a pump casing.

In certain embodiments, the communicating fluid pathway comprises an additional pipe spool comprising a second inner pipe and a second external pipe encircling the second inner pipe to provide an annular space between the second inner pipe and the second external pipe, the second external pipe having a flange connected to an end of the second external pipe and having an opening formed through the wall of the second external pipe near the point of connection of the second external pipe to the flange of the second external pipe, the flange of the second external pipe having an aperture formed through the flange and being spaced at a distance from the outer surface of the second external pipe, and having a manifold device secured to the outer surface of the second external pipe and secured to the flange of the second external pipe, the manifold device having a channel formed therein and positioned in fluid communication with the aperture formed through the flange of the second external pipe and the opening in the second external pipe, the method further comprising placing the aperture of the flange of the second external pipe in fluid communication with the aperture of the flange of the external pipe of the first jacketed pipe to direct fluid between communicating jacketed pipes.

In certain other embodiments, the communicating fluid pathway comprises a pump casing having a back wall, a discharge pipe and a conduit formed in the back wall and along the discharge pipe, the conduit having an entrance opening formed in the back wall of the pump casing and being positioned in fluid communication with the aperture of the flange connected to the eternal pipe to direct fluid from the annular space between the inner pipe and the external pipe to the conduit formed in the back wall of the pump casing.

In still other embodiments, the method further comprises providing a connector pipe secured to the discharge pipe of the pump casing, the connector pipe having a connector pipe conduit formed along an outer surface of the connector pipe and having a first opening positioned in fluid communication with an exit opening of the conduit formed in the pump casing at an outlet of the discharge pipe and directing fluid from the conduit of the pump casing to the connector conduit for delivery to a further communicating pathway.

Other aspects, features, and advantages will become apparent from the following detailed description when taken in conjunction with the accompanying drawings, which are a part of this disclosure and which illustrate, by way of example, principles of the inventions disclosed.

### DESCRIPTION OF THE FIGURES

The accompanying drawings facilitate an understanding of the various embodiments.

FIG. 1 is perspective view in cross section of a portion of a jacketed pipe and manifold device in accordance with this disclosure;

FIG. 2 is a perspective view in cross section of the jacketed pipe shown in FIG. 1 with the manifold device removed for ease of illustration;

FIG. 3 is a perspective view in cross section of two adjacent jacketed pipes;

FIG. 4 is a perspective view of one sample of a manifold device in accordance with the disclosure;

FIG. 5 is a perspective view of the manifold device shown in FIG. 4 illustrating the first surface and channel;

FIG. 6 is a perspective view of the manifold device shown in FIGS. 4 and 5;

FIG. 7 is a perspective view of an alternative manifold device configuration;

FIG. 8 is a perspective view of another alternative manifold device configuration;

FIG. 9 is a perspective view of still another alternative manifold device configuration;

FIG. 10 is a perspective view of yet another alternative manifold device configuration;

FIG. 11 is a perspective view of a jacketed pipe and manifold device connected to a pump casing;

FIG. 12 is a view in elevation of a cross section of a jacketed pipe connected to a pump casing;

FIG. 13 is a perspective view of a pump casing in accordance with the present disclosure;

FIG. 14 is a perspective view in partial cutaway of a pump casing in accordance with the disclosure;

FIG. 15 is a perspective view in cross section of a connector pipe in accordance with the present disclosure; and

FIG. 16 is a perspective view of one alternative arrangement for connecting adjacent pipe spools in accordance with the disclosure.

### DETAILED DESCRIPTION

In a first aspect of the disclosure, shown in FIG. 1, an arrangement, generally at 10, for directing fluid through a jacketed pipe system comprises an internal pipe 14 having a wall 16 with an outer surface 18, and an external pipe 20 coaxially arranged around the internal pipe 14 to form an annular space 24 between an inner surface 26 of a wall 28 of the external pipe 20 and the outer surface 18 of the internal pipe 14.

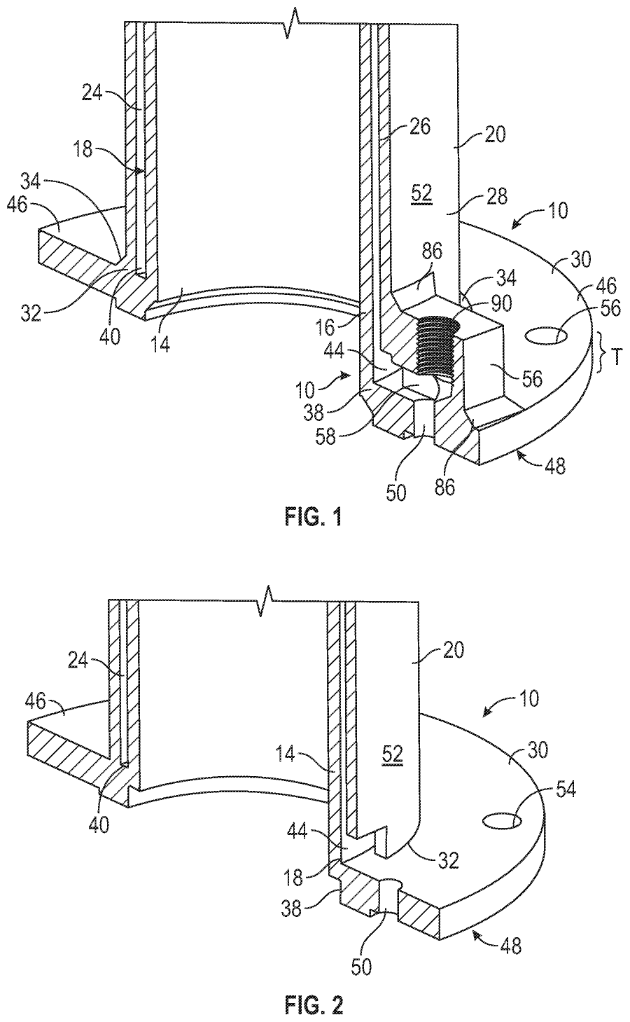

As best seen in FIG. 2, a flange 30 is connected to an end 32 of the external pipe 20. The flange 30 may be secured to the external pipe 20 by known means, such as by a weld 34. An inner diameter 38 of the flange 30 may register against the outer surface 18 of the internal pipe 14, and, in some embodiments, may be secured to the outer surface 18 of the internal pipe 14. As such, the annular space 24 is closed, or bottoms out, in the region 40 where the annular space adjoins the flange 30.

An opening 44 is formed through the wall 28 of the external pipe 20 near a point of connection of the flange 30 to the external pipe 20. The opening 44 is in fluid communication with the annular space 24 between the internal pipe 14 and the external pipe 20. Notably, at least one opening 44 is provided in the arrangement 10, but more than one opening 44 may be provided.

The flange 30 has a first surface 46 and an opposing second surface 48, with a thickness T therebetween. At least one aperture 50 extends through the thickness T of the flange 30 and is radially spaced from the point of connection of the flange 30 to the outer surface 52 of the external pipe 20. The at least one aperture 50 is located in radial proximity to the opening 44 formed through the wall 28 of the external pipe 20 and vice versa. The flange 30 is also structured in known fashion with a plurality of bore holes 54 which enable one flange 30 to be secured to an adjacent flange to connect adjacent pipe systems, or spools, together using bolts or equivalents means, or to connect the flange 30 to a pump casing as described more fully hereinafter.

A manifold device or manifold block 56 is connected to the outer surface 52 of the external pipe 20 and is connected to the first surface 46 of the flange 30. The manifold block 56 is positioned to enclose the opening 44 formed in the wall 28 of the external pipe 20 and to enclose the aperture 50 extending through the flange 30. The manifold block 56 is formed with a channel 58 that provides a fluid pathway between the opening 44 in the external pipe 20 and the aperture 50 in the flange 30. The arrangement 10 in accordant with this disclosure has at least one manifold device, but may have a plurality of manifold devices configured and positioned as described herein.

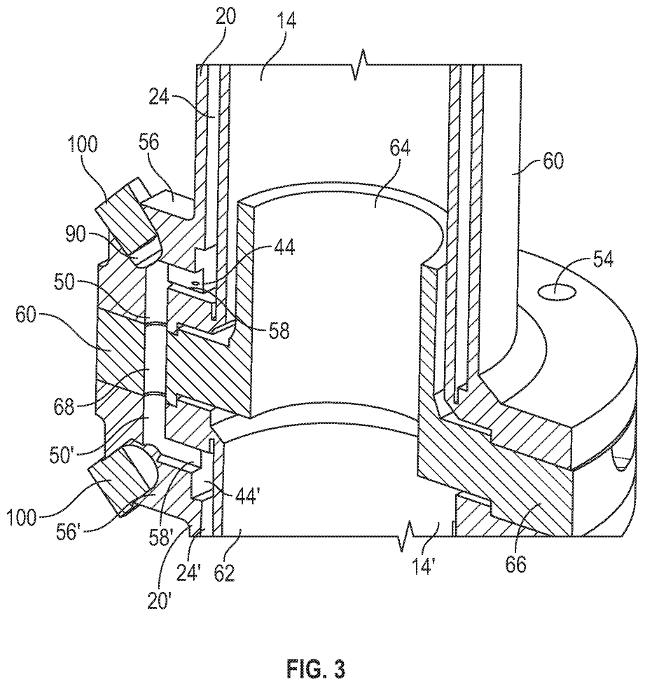

FIG. 3 illustrates one possible configuration of the arrangement 10 for directing fluid where a first jacketed pipe 60 is connected to a second jacketed pipe 62, each being comprised of an internal pipe 14, 14′ and an external pipe 20, 20′ with an annular space 24, 24′ formed therebetween. In this particular example of a configuration, an inner pipe string 64 having a radial pipe flange 66 attached to the inner pipe string 64, is arranged so that the radial pipe flange 66 is disposed between the flanges 30, 30′ of the first jacketed pipe 60 and second jacketed pipe 62. Notably, the continuing inner pipe portion of the inner pipe string 64 that would be disposed within the second jacketed pipe 62 is removed for ease of illustration. The radial pipe flange 66 of the inner pipe string 64 is configured with a throughput 68 which aligns with the apertures 50, 50′ of the connected first jacketed pipe 60 and second jacketed pipe 62. In operation, fluid moving through the annular space 24 of the first jacketed pipe 62 is directed through the opening 44 in the first jacketed pipe 60 and through the channel 58 of the manifold block 56, then through the aperture 50 of the first jacketed pipe 60, and through the throughput 68 of the inner pipe flange 66, thereafter moving through the aperture 50′ of the flange 30′ of the second jacketed pipe 62, through the channel 58′ in the manifold block 56′ of the second jacketed pipe 62 and from the opening 44′ through the external pipe 20′ of the second jacketed pipe 62 to the annular space 24′ of the second jacketed pipe 62.

In the assemblage depicted in FIG. 3, the inner pipe string 64 may be used to carry a main fluid, while the annular spaces 24 of the jacketed pipes 60, 62 that surround the inner pipe string 64 carry a mediating or other fluid, such as steam or a cooling fluid. It is to be noted, however, that the arrangement 10 of the disclosure may also be configured such that the internal pipe 14 of adjoining jacketed pipe spools can be used to carry or flow a main fluid therethrough, while the annular spaces 24, 24″ carry a mediating or other fluid, such as steam or a cooling fluid. Still, alternatively, an inner pipe string 64 may be configured such that the adjacent inner pipes are joined end-to-end without a connecting radial flange 66 and, in such a configuration, the two adjacent flanges 30, 30′ of the first jacketed pipe 60 and second jacketed pipe 62, respectively, would register against each other at their respective second surfaces 48 and would be bolted together such that the respective apertures 50, 50′ of the respective flanges 30, 30′ would be in alignment for directing a fluid from one to the next.

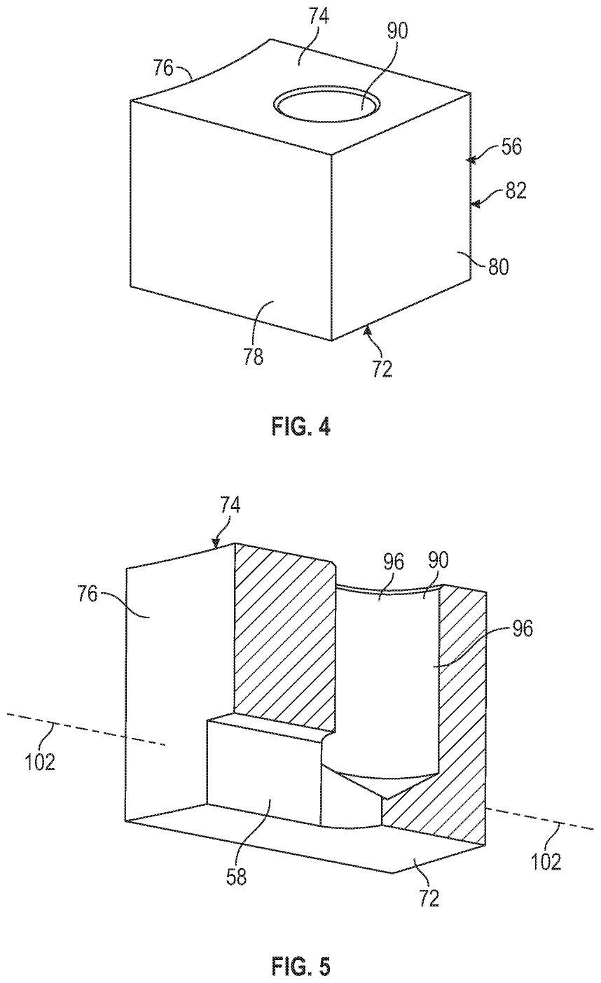

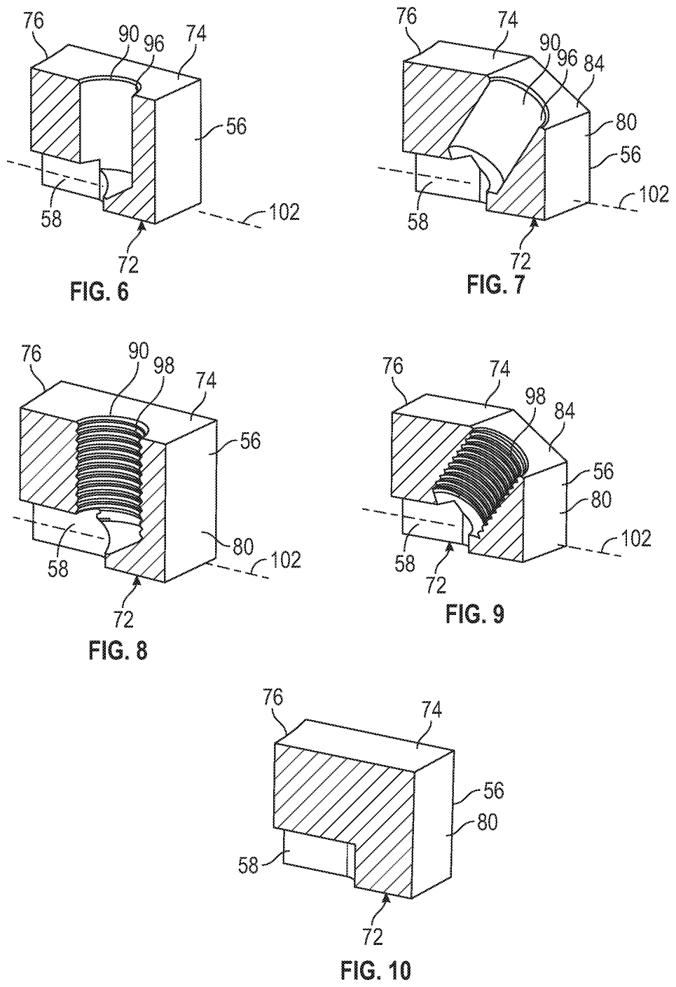

FIG. 4 through FIG. 10 depict alternative forms of the manifold device or manifold block 56 of the disclosure. FIGS. 4 and 5 depict one configuration of the manifold block 56 which has a number of sides or faces, including a first face 72 that is positioned against a first surface 46 of the flange 30. The channel 58 of the manifold block 56 is formed in the first face 72 of the manifold block 56, as shown in FIG. 5. The manifold block 56 has one or more opposing faces that are positioned in opposing orientation to the first face 72 of the manifold block 56. The opposing faces may include a second face 74 that is positioned in apposition to the first face 72 and parallel thereto. Another opposing face comprises a third face 76 which is oriented to register against the outer surface 52 of the wall 28 of the external pipe 20. Additional opposing faces may include a fourth face 78, a fifth face 80 and a sixth face 82, each of which extend between the first face 72 and the second face 74. Additional faces, such as a seventh face 86, formed between adjacent faces, i.e., second face 74 and fifth face 80, may be provided.

In use, the first face 72 of the manifold block 56 is secured to the first surface 46 of the flange 30, and the third face 76 of the manifold block 56 is secured against the outer surface 52 of the external pipe 20 by a weld 86, as shown in FIG. 1, which seals all edges of the faces of the manifold block 56 to the external pipe 20 and flange 30 to assure a fluid-tight seal. Other means of providing attachment of the manifold device to the jacketed pipe and flange, while providing a fluid seal, may be employed. Further, while the manifold device is principally illustrated herein in the form of a block, any other configuration may be employed that is not a block, per se, as long as the manifold device provides enclosure of the opening 44 in the external pipe 20 and closure of the aperture 50 in the flange 30 while providing a fluid pathway therebetween.

The manifold device or manifold block 56 may further be configured with an access port 90, as depicted in FIGS. 4-9. The access port 90 may be formed in an opposing face of the manifold block 56, such as in the second face 74, as shown in FIGS. 4, 5, 6 and 8. Alternatively, the access port 90 may be formed in any of the other opposing faces including the fourth face 78, fifth face 80, sixth face 82, or, as shown in FIGS. 7 and 9, a seventh face 84.

The access port 90 is in fluid communication with the channel 58 formed in the first face 72 of the manifold block 56 and may be provided to flush the circuit of interconnected annular spaces 24 for maintenance purposes, or to introduce a fluid into the circuit, or to discharge fluid from the circuit.

The access port 90 has an inner wall 96 that, in some embodiments, may present a smooth surface, as shown in FIG. 5-7. In other embodiments, the access port 90 has an inner wall 98 that is threaded, as shown in FIGS. 8 and 9. As such, auxiliary piping may be inserted and secured in the access port by friction fit, in the case where the inner wall 96 is smooth, or may be secured by interlocking threaded means in the case of the inner wall 98 being threaded. Additionally, the access port 90 may be capped off or closed by a plug 100, as shown in FIG. 3, such cap or plug 100 being secured by friction fit or by threading, or any other means that provides a comprehensive sealing of the access port 90 to fluid loss.

The access port 90 is oriented at an angle to a longitudinal axis 102 formed along the channel 58 of the manifold block 56. In one embodiment, the access port 90 is oriented at an angle that is perpendicular to the longitudinal axis 102 of the channel 58, as shown in FIGS. 5, 6 and 8. Alternatively, the access port 90 may be oriented at an acute angle relative to the longitudinal axis 102 of the channel 58, as shown in FIGS. 7 and 9. The angle of the access port 90 relative to the channel 58 may be dictated by the configuration of the jacketed pipe spools and their arrangement relative to each other to provide an orientation that best facilitates access to the at least one manifold device and its associated access port 90.

In still another embodiment, the manifold device or manifold block 56 may be devoid of an access port, as shown in FIG. 10.

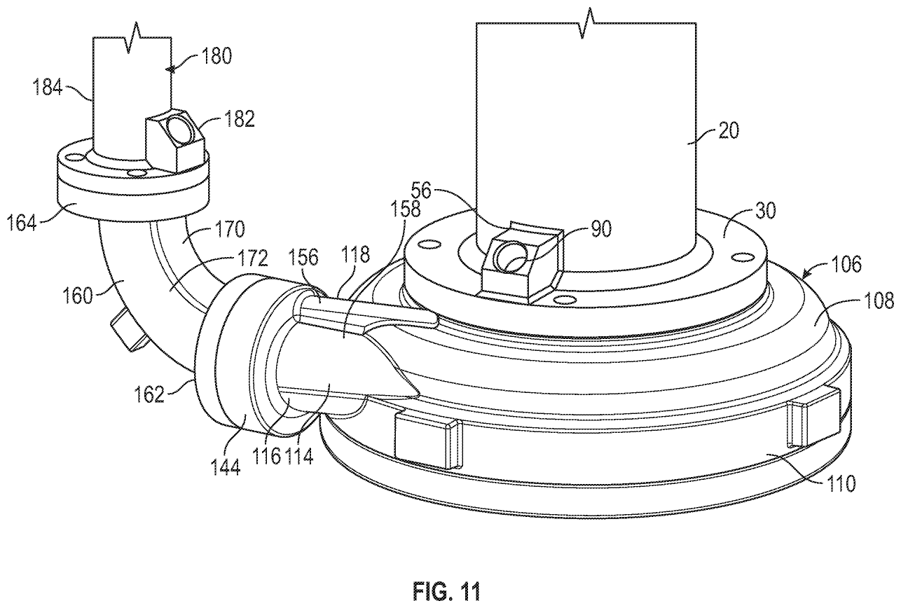

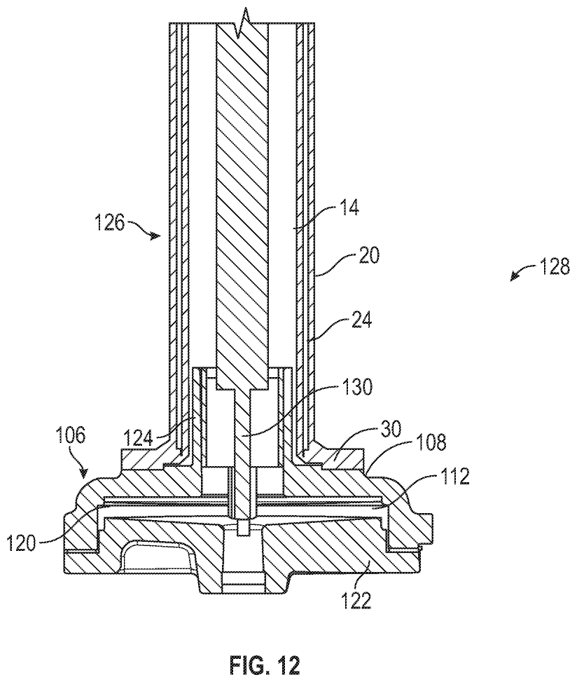

In a further application of the arrangement 10 for directing fluid in accordance with the disclosure, the flange 30 may be secured to a pump casing 106, as shown in FIG. 11. The arrangement 10 further comprises a pump casing 106 having a back wall 108 and circumferential wall 110 defining, in combination, a volute 112 (FIG. 12) which provides a pump chamber 120 sized to receive an impeller 122. The pump casing 106 also has a discharge pipe 114, extending from the volute 112, the discharge pipe 114 having an outlet 116 spaced from the volute 112. A conduit 118 is formed in the pump casing to provide a fluid pathway from the back wall 108 to the outlet 116 of the discharge pipe 114, the conduit being positioned and arranged to not be in fluid communication with either the pump chamber 120 or the fluid in the discharge pipe 114.

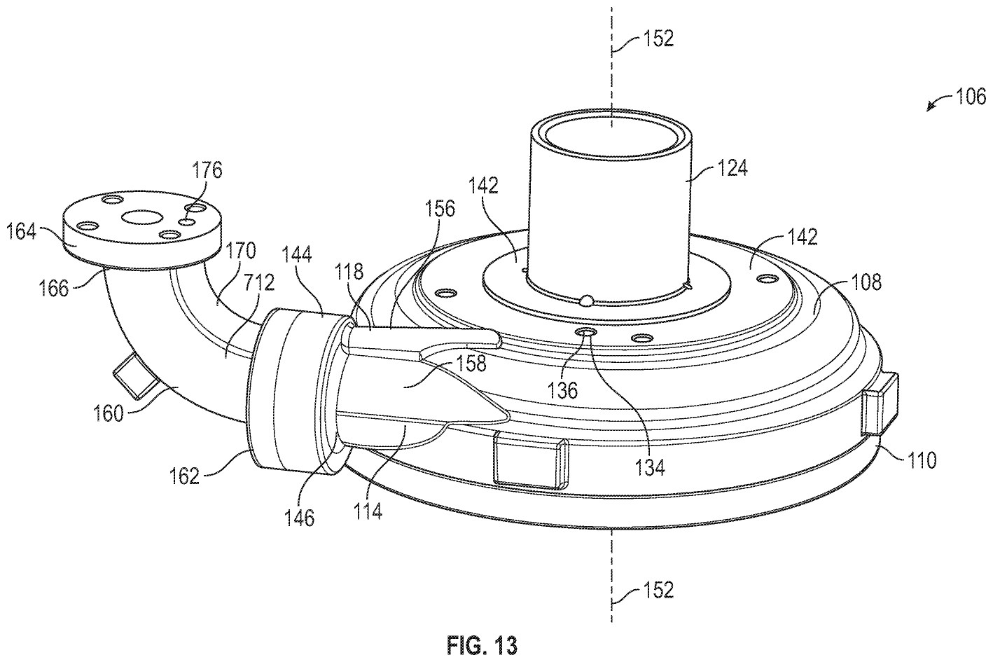

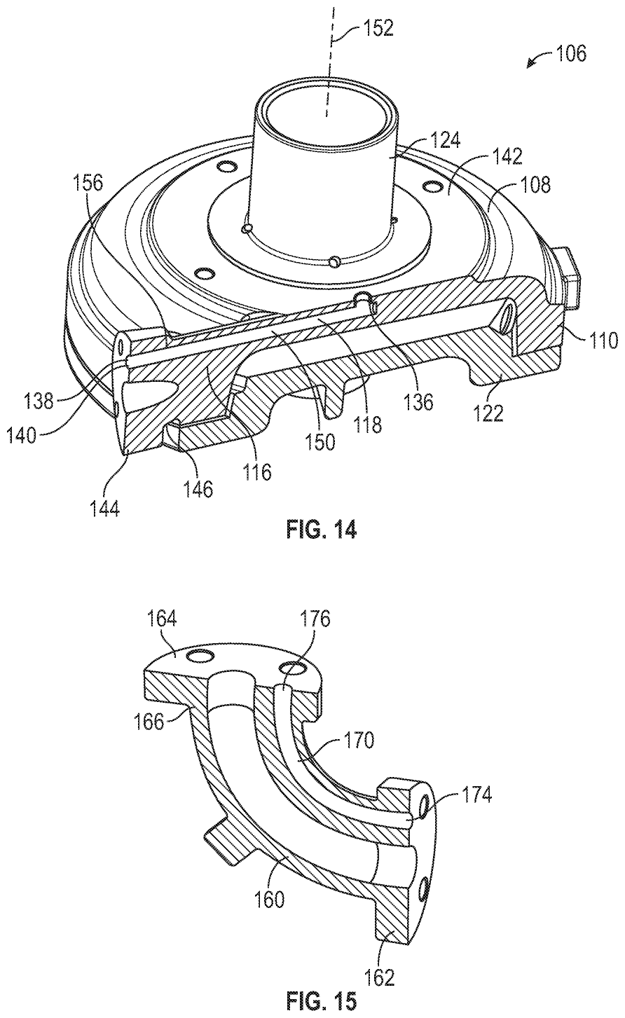

As best seen in FIGS. 12 and 13, the pump casing 106 may be configured with an upstanding sleeve 124 which provides support for the internal pipe 14 of the jacketed pipe 126, which surrounds the upstanding sleeve 124. The upstanding sleeve 124 also provides a housing for part of the drive components of the pump 128, such as a drive shaft 130 and associated bearings and seals (not shown).

The conduit 118 has a first opening 134 or entrance opening 136 positioned through the outer surface 142 of the back wall 108 of the pump casing 106. In assembly, the second surface 48 of the flange 30 of a jacketed pipe is positioned in registration with the outer surface 142 of the back wall 108, and is located to align the aperture 50 of the flange 30 with the entrance opening 136 of the conduit 118. The entrance opening 136, therefore, receives fluid from the annular space 24 between the internal pipe 14 and the external pipe 20 via the channel 58 formed in the manifold device 56 and directed through the channel 58 into the aperture 50 of the flange 30.

The conduit 118 has a second opening 138 or exit opening 140 located in proximity to the discharge pipe 114. The discharge pipe 114 of the pump casing 106 further includes a discharge flange 144 located at an end 146 of the discharge pipe 114 and the conduit 118 extends to and through the discharge flange 144, the second opening 138 or exit opening 140 of the conduit 118 being formed through the discharge flange 144 of the pump casing 106.

In some embodiments, the conduit 118 comprises a bore 150 that is formed through the back wall 108 of the pump casing 106 in a generally radial direction relative to a rotational axis 152 through the pump casing 106. Stated otherwise, the bore 150 defining the conduit 118 lies is a plane that is parallel to a plane in which the outer surface 142 of the back wall 108 lies and in a place that is perpendicular to a plane in which the rotational axis 152 lies. The bore 150 is not in fluid communication with the pump chamber 120 of the pump casing 106. Additionally, the bore 150 of the conduit 118 may lie, in part, within a sleeve 156 formed along an outer surface 158 of the discharge pipe 114 and, consequently, is not in fluid communication with the interior of the discharge pipe 114.

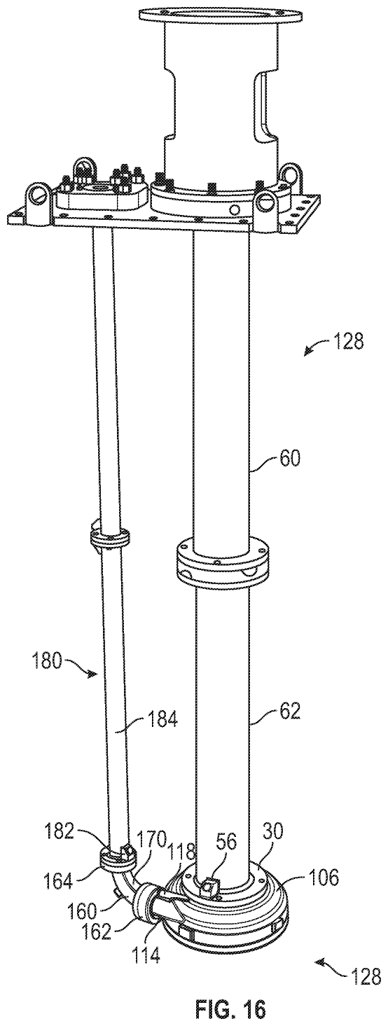

In a further arrangement depicted in FIGS. 11 and 13, a connector pipe 160 having a first radial flange 162 may be provided for securement to the discharge flange 144 of the discharge pipe 114. The connector pipe 160 may also have a second radial flange 164 located at an opposing end 166 of the connector pipe 160 for securing the connector pipe 160 to other piping elements, as shown in FIG. 16.

As best seen in FIG. 15, the connector pipe 160 has a connector pipe conduit 170 formed along an outer surface 172 of the connector pipe 160, the connector pipe conduit 170 having a first opening 174 positioned through the first radial flange 162. When the first radial flange 162 of the connector pipe 160 is secured to the discharge flange 144 of the discharge pipe 114, the first opening 174 of the connector pipe conduit 170 is aligned with the exit opening 140 formed in the discharge flange 144 so that fluid may be directed from the conduit 118 of the pump casing 106 to the connector pipe conduit 170. The connector pipe conduit 170 also has a second opening 176 formed in the second radial flange 164 of the connector pipe 160.

Thus, in one arrangement of adjacent pipe spools shown in FIG. 16, fluid, such as steam, may be directed from a first jacketed pipe 60, configured as previously described, to an adjacently connected second jacketed pipe 62, configured as previously described, the second jacketed pipe 62 being connected to a pump casing 106 as previously described. The directed fluid, such as steam, can be directed through conduit 118 of the pump casing 106 and discharge pipe 114 through the connector pipe conduit 170 of the connector pipe 160 and then to and through a further pipe spool 180, which may be similarly configured as described with respect to the first and second jacketed pipes 60, 62, the further pipe spool 180 being configured with a manifold device 182 which provides for the direction of fluid from the connector pipe conduit 170 to the further pipe spool 180 in the manner previously described herein. The other pipe spool 180 may or may not be a jacketed pipe and if not jacketed, the manifold device 182 delivers fluid directly to the interior of the pipe 184 of the other pipe spool 180.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the inventions, and alterations, modifications, additions and/or changes can be made thereto without departing from the scope and spirit of the disclosed embodiments, the embodiments being illustrative and not restrictive.

Furthermore, inventions have been described in connection with what are presently considered to be the most practical and preferred embodiments, it is to be understood that the inventions are not to be limited to the disclosed embodiments, but on the contrary, are intended to cover various modifications and equivalent arrangements included within the spirit and scope of the inventions. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

### REFERENCE NUMERALS

Jacketing arrangement 10
Internal pipe 14
Internal pipe wall 16
Internal pipe wall outer surface 18
External pipe 20
Annular space 24
Inner surface (of external pipe) 26
Wall (of external pipe) 28
Flange 30
External pipe end 32
Weld 34
Inner diameter 38
Region 40
Opening 44
First surface (of flange) 46
Opposing second surface (of flange) 48
Aperture 50
Outer surface (of external pipe) 52
Bore holes 54
Manifold device (or block) 56, 182
Channel (of manifold block) 58
First jacketed pipe 60
Second jacketed pipe 62
Inner pipe string 64
Radial pipe flange 66
Throughput 68
First face (of manifold block) 72
Second face (of manifold block) 74
Third face (of manifold block) 76
Fourth face (of manifold block) 78
Fifth face (of manifold block) 80
Sixth face (of manifold block) 82
Seventh face (of manifold block) 84
Weld 86
Access port 90
Inner wall (of access port) 96
Threaded inner wall (of access port) 98
Plug (for access port) 100
Longitudinal axis (of the channel) 102
Pump casing 106
Back wall (of pump casing) 108
Circumferential wall (of pump casing) 110
Volute (of pump casing) 112
Discharge pipe (of pump casing) 114
Conduit 118
Pump chamber 120
Impeller 122
Outlet (of discharge pipe) 116
Upstanding sleeve (of pump casing) 124
Jacketed pipe 126
Pump 128
Drive shaft 130
First (entrance) opening (of conduit) 134, 136
Outer surface (of back wall) 142
Second (exit) opening (of conduit) 138, 140
Discharge flange (of discharge pipe) 144
End (of discharge pipe) 146
Bore (of conduit) 150
Rotational axis 152
Sleeve 156
Outer surface (of discharge pipe) 158
Connector pipe 160
First radial flange 162
Second radial flange 164
Opposing end (of connector pipe) 166
Connector pipe conduit 170
Outer surface (of connector pipe) 172
First opening 174
Second opening 176
Further pipe spool 180
Pipe 184

1. A jacketed pipe comprising an internal pipe, an external pipe, a flange and at least one manifold device manufactured as separate parts,
the internal pipe having a wall with an outer surface;
the external pipe coaxially arranged around the internal pipe to form an annular space between an inner surface of a wall of the external pipe and the outer surface of the internal pipe;
the flange having a first surface and an opposing second surface, the flange being connected to an end of the external pipe and the internal pipe, the flange having at least one aperture extending through the thickness of the flange from the first surface to the opposing second surface and being radially spaced from the point of connection of the flange to the outer surface of the external pipe;
an opening formed through the wall of the external pipe near a point of connection of the flange to the external pipe, the opening being in fluid communication with the annular space between the internal pipe and the external pipe and being located in radial proximity to the at least one aperture formed through the flange; and
the at least one manifold device connected to the outer surface of the external pipe and connected to the first surface of the flange, the at least one manifold device being positioned to enclose the opening formed in the external pipe and to enclose the aperture extending through the flange, the at least one manifold device being formed with a channel providing a fluid pathway between the opening in the external pipe and the aperture in the flange allowing the annular space and the aperture in the flange to be in fluid communication.

2. The jacketed pipe according to claim 1, wherein the at least one manifold device has a first face that is positioned against the first surface of the flange, the channel being formed in the first face of the at least one manifold device.

3. The jacketed pipe according to claim 2, wherein the at least one manifold device has an opposing face that is positioned in opposing orientation to the first face of the at least one manifold device.

4. The jacketed pipe according to claim 3, wherein an access port is formed in the opposing face of the at least one manifold device, the access port being in fluid communication with the channel of the at least one manifold device.

5. The jacketed pipe according to claim 4, wherein the access port is oriented at an angle to a longitudinal axis formed along the channel.

6. The jacketed pipe according to claim 5, wherein the angle of orientation of the access port is perpendicular to the channel and the opposing face is a second face that is positioned parallel to the first face of the manifold device, the access port being formed through the second face.

7. The jacketed pipe according to claim 5, wherein the angle of orientation of the access port relative to the longitudinal axis of the channel is an acute angle.

8. The jacketed pipe according to claim 4, wherein the access port has an inner wall that is threaded.

9. The jacketed pipe according to claim 2, wherein the at least one manifold device is further provided with a third face that is positioned against the wall of the external pipe and is connected to the wall of the external pipe.

10-12. (canceled)

13. A centrifugal pump casing for attaching a jacketed pipe according to claim 1 thereto, the centrifugal pump casing, comprising:
a back wall defining an outer surface and a circumferential wall extending away from the back wall opposed to the outer surface, the back wall and circumferential wall defining, in combination, a volute which provides a pump chamber opposed to the outer surface sized to receive an impeller;
a discharge pipe extending from the volute and having an inlet in communication with the pump chamber and an outlet spaced from the volute, the impeller configured to draw a main fluid into the pumping chamber and discharge the main fluid via the discharge pipe; and
a conduit having an entrance opening formed in the outer surface of the back wall and an exit opening located in proximity to the discharge pipe providing a fluid pathway for a mediating fluid from the back wall to the outlet of the discharge pipe, the conduit being positioned to not be in fluid communication with the volute, pump chamber or the discharge pipe;
wherein the discharge pipe further comprises a discharge flange having an outer axial face with the discharge outlet extending axially through the discharge flange towards the outer axial face, and wherein the conduit extends from the entrance opening to and axially through the discharge flange so that the exit opening of the conduit is formed in the outer axial face of the discharge flange and is radially spaced from the outlet.

14-15. (canceled)

16. A pump assembly, comprising:
a jacketed pipe comprising an internal pipe, an external pipe, a flange and a manifold device manufactured as separate parts, the internal pipe having a wall with an outer surface, the external pipe being coaxially arranged around the internal pipe to form an annular space between an inner surface of a wall of the external pipe and the outer surface of the internal pipe, the flange having a first surface and an opposing second surface, the flange being connected to an end of the external pipe and the internal pipe, the flange having at least one aperture extending through the thickness of the flange from the first surface to the opposing second surface and being radially spaced from the point of connection of the flange to the outer surface of the external pipe, an opening formed through the wall of the external pipe near a point of connection of the flange to the external pipe, the opening being in fluid communication with the annular space between the internal pipe and the external pipe and being located in radial proximity to the at least one aperture formed through the flange, and the manifold device being connected to the outer surface of the external pipe and connected to the first surface of the flange, the manifold device being positioned to enclose the opening formed in the external pipe and to enclose the aperture extending through the flange, the manifold device being formed with a channel providing a fluid pathway between the opening in the external pipe and the aperture in the flange allowing the annular space and the aperture in the flange to be in fluid communication; and
a centrifugal pump casing comprising,
a back wall defining an outer surface and a circumferential wall extending away from the back wall opposed to the outer surface, the back wall and circumferential wall defining, in combination, a volute which provides a pump chamber opposed to the outer surface sized to receive an impeller,
a discharge pipe extending from the volute and having an inlet in communication with the pump chamber and an outlet spaced from the volute, the impeller configured to draw a main fluid into the pumping chamber and discharge the main fluid via the discharge pipe; and
a conduit having an entrance opening formed in the outer surface of the back wall and an exit opening located in proximity to the discharge pipe providing a fluid pathway for a mediating fluid from the back wall to the outlet of the discharge pipe, the conduit being positioned to not be in fluid communication with the volute, pump chamber or the discharge pipe;
wherein the discharge pipe further comprises a discharge flange having an outer axial face with the discharge outlet extending axially through the discharge flange towards the outer axial face, and wherein the conduit extends from the entrance opening to and axially through the discharge flange so that the exit opening of the conduit is formed in the outer axial face of the discharge flange and is radially spaced from the outlet;
wherein the pump casing is attached to the flange of the jacketed pipe, so that the entrance opening of the conduit is aligned with the aperture formed through the flange of the jacketed pipe to receive mediating fluid from the annular space between the internal pipe and the external pipe.

17. The pump assembly according to claim 16, further comprising a connector pipe having a first radial flange for securement to the flange of the discharge pipe, and having a second radial flange located at an opposing end of the connector pipe for securing the connector pipe to other piping elements, the connector pipe having a connector pipe conduit formed along an outer surface of the connector pipe extending axially through the first radial flange, and having a first opening positioned in an axial outer face of the first radial flange in alignment with the exit opening of the conduit formed in the outer axial face of the discharge flange, and axially through the second radial flange and having a second opening in an axial outer face of the second radial flange.
